(19) United States
(12) Patent Application Publication
(10) Pub. No.: US 2008/0304775 A1
(43) Pub. Date: Dec. 11, 2008

(54) HYDRODYNAMIC BEARING DEVICE, AND RECORDING AND REPRODUCING APPARATUS EQUIPPED WITH SAME

(76) Inventors: Takafumi Asada, Osaka (JP); Hiroaki Saito, Ehime (JP); Daisuke Ito, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/120,030

(22) Filed: May 13, 2008

(30) Foreign Application Priority Data
May 14, 2007 (JP) 2007-127600

(51) Int. Cl. F16C 32/06

(52) U.S. Cl. 384/112

(57) ABSTRACT

There is provided a hydrodynamic bearing device that maintains high bearing angular stiffness, and that prevents oil film separation in the bearing by smoothly discharging any bubbles present inside the bearing. With a hydrodynamic bearing device, a communicating hole and a radial hydrodynamic groove constitute a circulation path for a lubricant, and a first thrust bearing surface is provided at a location in contact with the circulation path. A first hydrodynamic groove formed in the first thrust bearing surface is a spiral groove with a pump-in pattern. Any bubbles in the bearing are smoothly discharged by the circulation of the lubricant produced by the asymmetrical radial hydrodynamic groove. The pressure generated at the thrust bearing surface during rotation of the bearing has a distribution such that there is a wide range of high pressure.

### BACKGROUND OF THE INVENTION

1. Field of the Invention

The present invention relates to a hydrodynamic bearing device and a recording and reproducing apparatus equipped with this bearing device.

2. Description of the Related Art

Recording apparatuses and so forth that make use of a rotating disk have grown in memory capacity in recent years, and their data transfer rates have also been on the rise. The bearings used in these recording apparatuses therefore need to offer high reliability and performance for always keeping a disk load rotating with high accuracy. Hydrodynamic bearing devices, which are well suited to high-speed rotation, have been used in these rotational apparatuses.

An example of a conventional hydrodynamic bearing device and recording and reproducing apparatus will now be described through reference to FIG. 13.

As shown in FIG. 13, a conventional hydrodynamic bearing device has a sleeve 121, a shaft 122, a flange portion 123, a thrust plate 124, a seal cap 125, a lubricant (oil) 126, a hub 127, a base 128, a rotor magnet 129, and a stator 130.

The shaft 122 is integrated with the flange portion 123, and is rotatably inserted in a bearing hole 121A of the sleeve 121. The flange portion 123 is accommodated in a step portion 121C of the sleeve 121. A radial hydrodynamic groove 121B is formed in the outer peripheral surface of the shaft 122 and/or the inner peripheral surface of the sleeve 121. A first thrust hydrodynamic groove 123A is formed in the surface of the flange portion 123 that is opposite the thrust plate 124. A second thrust hydrodynamic groove 123B is formed in the surface of the flange portion 123 that is opposite the sleeve 121. The thrust plate 124 is affixed to the sleeve 121 or the base 128. At least the bearing gaps near the hydrodynamic grooves 121B, 123A, and 123B are filled with the lubricant 126. If needed, the lubricant 126 may fill the entire pocket-shaped space formed by the sleeve 121, the shaft 122, and the thrust plate 124. The seal cap 125 has a fixed portion 125A attached near the upper end surface of the sleeve 121, an inclined portion (tapered portion) 125B, and a vent hole 125C. A communicating hole 121G is provided substantially parallel to the bearing hole 121A, and allows the lubricant reservoir (oil reservoir) of the seal cap 125 to communicate with the area near the outer periphery of the flange portion 123. The communicating hole 121G, the radial hydrodynamic groove 121B, and the second thrust hydrodynamic groove 123B form the circulation path of the lubricant 126. A bubble 135 that has been generated or admixed is schematically shown as being in the interior of the bearing.

The sleeve 121 is fixed to the base 128. The stator 130 is fixed to the base 128 so as to be opposite the rotor magnet 129. When the base 128 is a magnetic material, the rotor magnet 129 generates an attractive force in the axial direction by means of leaked magnetic flux. This presses the hub 127 in the direction of the thrust plate 124 at a force of approximately 10 to 100 grams.

Meanwhile, the hub 127 is fixed to the shaft 122, and the rotor magnet 129, a disk 131, a spacer 132, a clamper 133, and a screw 134 are also fixed.

Patent Document 1: Japanese Laid-Open Patent Application H8-331796

Patent Document 2: Japanese Laid-Open Patent Application 2006-170344

Patent Document 3: Japanese Laid-Open Patent Application 2001-173645

### SUMMARY OF THE INVENTION

### Problem to be Solved by the Invention

However, the following problems are encountered with the conventional hydrodynamic bearing device discussed above.

In FIG. 13, the first thrust hydrodynamic groove 123A, which is provided to the opposing surfaces of the shaft 122 and the thrust plate 124 fixed in the back part of the bearing cavity (the entire bearing gap), or to the opposing surfaces of the flange portion 123 and the thrust plate 124, has a herringbone pattern or a spiral pattern. For example, when the first thrust hydrodynamic groove 123A has a herringbone pattern, a vacuum portion or a portion where the pressure is far lower than atmospheric pressure is produced at the center of the pattern. Thus, a problem is that bubbles 135 tend to accumulate and remain inside the bearing.

Meanwhile, when the first thrust hydrodynamic groove 123A has a spiral pattern, as shown in FIG. 14, the pressure generated at the bearing surfaces during the rotation of the bearing is high within the narrow range L2 in the middle. A problem with a pressure distribution such as this is that the moment stiffness (known as the angular stiffness or rotational stiffness) generated between the thrust plate 124 and the shaft 122 is low.

The reason this phenomenon occurs is that the generated pressure distribution is low near the outer periphery of the pattern, so the recovery force is lower with respect to inclination of the shaft. That is, the pressure generated near the center of the groove pattern works as a repulsive force that supports a load in the thrust direction, but the pressure generated near the outer periphery of the groove pattern is what mainly contributes to the angular stiffness (moment stiffness), which is the recovery force with respect to inclination of the shaft. Thus, the pressure in the middle of a groove pattern distributed over a narrow range tends not to contribute to higher performance in terms of angular stiffness (moment stiffness). Therefore, with the configuration shown in FIG. 14, when the rotational device is swung forcefully, or when the shaft is subjected to an inclination moment, for example, the rotational center of the shaft 122 tilts, and there is the risk that the bearing will rub or seize, and that the rotational device or the entire disk recording device will cease to operate.

It is an object of the present invention to provide a hydrodynamic bearing device and a recording and reproducing apparatus with which any bubbles present in the bearing can be smoothly discharged, and the moment stiffness in the thrust bearing can be increased, which affords more stable performance.

### Means for Solving Problem

The hydrodynamic bearing device pertaining to the present invention comprises a shaft, a sleeve, a lubricant, a communicating hole, and a first thrust bearing surface. The sleeve has a bearing hole with an open end that opens and a closed end that is blocked off by a blocking member in the axial direction, and into which the shaft is inserted in so as to be capable of relative rotation. The lubricant fills a microscopic gap between the shaft and the sleeve. The communicating hole constitutes the circulation path of the lubricant along with the microscopic gap. The first thrust bearing surface is such that a first thrust hydrodynamic groove is formed as a pump-in pattern spiral groove on the blocking member and/or the shaft. The pump-in pattern spiral groove is formed in a ring-shaped region having a groove-free region in the center. The first thrust hydrodynamic groove is disposed near the circulation path.

### EFFECTS OF THE INVENTION

With the present invention, any bubbles present in the bearing are smoothly discharged, making it less likely that there will not be enough lubricant on the thrust bearing surface, and since the angular stiffness (moment stiffness) generated between the thrust plate and the shaft (or the flange) is high, a hydrodynamic bearing device can be obtained with higher reliability with respect to external forces.

### DETAILED DESCRIPTION OF THE INVENTION

Embodiments that specifically illustrate the best mode for carrying out the invention will now be described through reference to the drawings.

### Embodiment 1

An example of the hydrodynamic bearing device and recording and reproducing apparatus pertaining to Embodiment 1 will be described through reference to FIGS. 1 to 4.

As shown in FIG. 1, the hydrodynamic bearing device in this embodiment comprises a sleeve 1, a shaft 2, a flange portion 3, a thrust plate (blocking member) 4, a seal cap 5, a hub 7, a base 8, a rotor magnet 9, and a stator 10.

The sleeve 1 has an open end on one side in the axial direction of an opening that forms a bearing hole 1A, and a closed end on the other side. The shaft 2, which is supported in the bearing hole 1A, is inserted in the open end side of the sleeve 1. The thrust plate 4, which serves as a blocking member, is fixed at the closed end side of the sleeve 1.

The shaft 2 is integrated with the flange portion 3, and is inserted in a state of being capable of rotation in the bearing hole 1A of the sleeve 1.

The flange portion 3 is accommodated in a stepped area 1C.

A radial hydrodynamic groove 1B consisting of an asymmetrical herringbone pattern groove is formed in the outer peripheral surface of the shaft 2 and/or the inner peripheral surface of the sleeve 1. One herringbone groove is shown in FIG. 1, but there may be two herringbone grooves (upper and lower), with at least one of them having an asymmetrical shape. Meanwhile, a first thrust hydrodynamic groove 3A is formed in at least one opposing surface of the thrust plate 4 and the flange portion 3. If needed, a second thrust hydrodynamic groove 3B is formed in at least one opposing surface of the sleeve 1 and the flange portion 3.

The thrust plate 4 is fixed as a blocking member to the sleeve 1 or the base 8.

The bearing gaps near the hydrodynamic grooves 1B, 3A, and 3B are filled with a lubricant 6. If needed, the lubricant 6 may fill the entire pocket-shaped bearing gap formed by the sleeve 1, the shaft 2, and the thrust plate 4. Oil, high-fluidity grease, an ionic liquid, or the like can be used as the lubricant 6.

The seal cap 5 is positioned at the upper end of the sleeve 1, and has a fixed portion 5A attached to the sleeve 1 or the base 8, an inclined portion 5B, and vent hole 5C. In the drawings, the seal cap 5 has a shape that is tapered overall, but just the inner peripheral part may be tapered. Also, the seal cap 5 may not have a tapered shape.

A communicating hole 1G is provided substantially parallel to the bearing hole 1A, and allows a lubricant reservoir (oil reservoir) 1S of the seal cap 5 to communicate with the area near the outer periphery of the flange portion 3. The communicating hole 1G, the radial hydrodynamic groove 1B, and the second thrust hydrodynamic groove 3B are provided so as to communicate, and a circulation path of the lubricant 6 is constituted by the radial hydrodynamic groove 1B to second thrust hydrodynamic groove 3B, the communicating hole 1G, and the lubricant reservoir (oil reservoir) 1S. Also, the communicating hole 1G is formed, for example, as a hole, one or more of which are provided inside the sleeve 1 by drilling or the like. The communicating hole 1G may be constituted as a communicating groove between the sleeve 1 and the inner peripheral part of the seal cap, etc., that cover the outer periphery portion of the sleeve 1, with this groove being formed longitudinally by molding, etc., at the outer peripheral part of the sleeve 1.

The first thrust hydrodynamic groove 3A is a ring-shaped spiral groove with a pump-in pattern, which is provided so as to be in contact with, or adjacent to, the circulation path of the lubricant 6, and which has in its center a groove-free region with no hydrodynamic groove.

A bubble 15 generated by negative pressure (below atmospheric pressure) or by the entrainment of air from the interface is shown schematically in the interior of the bearing.

The outer peripheral part of the sleeve 1 is fixed to the base 8. Furthermore, the stator 10 is fixed to the base 8 at a location opposite to the rotor magnet 9.

If the base 8 is a magnetic body, the rotor magnet 9 generates an attractive force in the axial direction by means of leaked magnetic flux, and the hub 7 is pressed in the direction of the thrust plate 4 at a force of approximately 10 to 100 grams. if the base 8 is a non-magnetic body, however, the rotor magnet 9 generates an attractive force by fixing an attraction plate (not shown) over the base under the end surface.

The hub 7 is fixed to the end of the shaft 2, and the rotor magnet 9, a recording disk 11, a spacer 12, a clamper 13, and a screw 14 are fixed.

Next, the operation of the hydrodynamic bearing device in Embodiment 1 will be described through reference to FIGS. 2 to 4.

With the hydrodynamic bearing device in this embodiment, when rotation begins in the state shown in FIG. 2, the lubricant 6 is raked together by the radial hydrodynamic groove 1B, and this generates pressure. Also, just as with the first thrust hydrodynamic groove 3A, generating pressure by raking together the lubricant 6 lifts the shaft 2 within the bearing hole 1A, and causes the shaft 2 to rotate in a non-contact state.

The radial hydrodynamic groove 1B, which has a herringbone pattern, generates a pumping force to deliver the lubricant 6 in the direction of the white arrow in the drawing. The radial hydrodynamic groove 1B has a groove pattern designed so that during rotation, the lubricant 6 in the gap of the inclined portion 5B of the seal cap 5 will be transported through the bearing hole 1A and in the direction of the black arrow in the drawing. Therefore, the lubricant 6 flows through the second thrust hydrodynamic groove 3B into the communicating hole 1G, and accumulates again while circulating to the inclined portion 5B and the lubricant reservoir (oil reservoir) 1S of the seal cap 5. The lubricant 6 and the bubbles 15 are separated by the inclined portion 5B of the seal cap 5, and the lubricant 6 flows back into the radial hydrodynamic groove 1B. The separated bubbles 15 are discharged from the vent hole 5C. As a result, the lubricant 6 is supplied to the bearing gaps without interruption, so the shaft 2 can rotate in a state of non-contact with respect to the sleeve 1 and the thrust plate 4. Thus, data can be recorded to or reproduced from the rotating recording disk 11 by using a magnetic or optical head (not shown).

The first thrust hydrodynamic groove 3A is provided in contact with, or adjacent to, the circulation path of the lubricant 6. Also, the first thrust hydrodynamic groove 3A is a spiral groove with a pump-in pattern formed in a ring-shaped region having in its center a groove-free region. The term “groove-free region” as used here refers to a region in which is not formed the hydrodynamic groove disposed in the center of the first thrust hydrodynamic groove 3A formed in a ring shape as mentioned above. Thus, bubbles tend not to accumulate in the first thrust hydrodynamic groove 3A, and bubbles are smoothly discharged from the communicating hole, so the problem of insufficient lubricant 6 on the thrust bearing surface can be avoided.

Here, as shown in FIG. 3, the first thrust hydrodynamic groove 3A has a spiral pattern with a sufficiently large inside diameter (Di), and is a pump-in pattern that raises the internal pressure by rotating. With this configuration the pressure is higher in the middle, so no negative pressure (below atmospheric pressure) is generated, and bubbles are less likely to generate or accumulate. Therefore, the first thrust hydrodynamic groove 3A has the effect of reducing the accumulation of bubbles, and, since the range L1 over which the pressure is high in FIG. 3 is wider than the range L2 over which the pressure is high in FIG. 14, it also has the effect of raising the angular stiffness (moment stiffness) of the hydrodynamic bearing device. With a configuration such as this, because the inside diameter Di is greater than in the configuration discussed above (FIG. 14), the pressure distribution is as shown in the graph of FIG. 3. That is, unlike the pressure distribution in FIG. 14, in which there is only a narrow range over which the pressure in the middle is high, this is a pressure distribution with a wider range over which the pressure in the middle is high. Since the shaft is supported by a high-pressure portion with a wide span as indicated by the arrows in FIG. 3, rather than being supported by a high-pressure portion with a substantially short span as indicated by the arrow in FIG. 14, the momentum that returns the shaft to its original position after being tilted can be increased. Accordingly, a bearing with higher angular stiffness (moment stiffness) can be obtained. Furthermore, negative pressure is generally not produced on the inner peripheral side with a spiral pattern. Thus, it should go without saying that there is less risk of bubbles being generated.

FIG. 4 is a diagram of the flow of lubricant and the generated pressure in the hydrodynamic groove formed by the members of the hydrodynamic bearing device in FIG. 3.

FIG. 4 shows a thrust plate 24 and an integrated shaft 22 and flange portion 23. The white portion on the left side of FIG. 4 is a schematic illustration of the circulation path, comprising a radial hydrodynamic portion (bearing hole 21A), a second thrust hydrodynamic portion, a communicating hole 21G, and a lubricant reservoir 21S. Pr and the longer white arrow α (on the shaft drawing) in the drawing represent the pumping pressure of the radial hydrodynamic portion and the direction of this pressure, while Pt and the shorter arrows β (on the flange drawing) represent the pumping pressure of the second thrust hydrodynamic portion and the directions of this pressure. The arrows γ represent the pumping pressure generated by the spiral hydrodynamic groove of the first thrust hydrodynamic portion and the directions of this pressure. The pumping pressure indicated by the arrows β and β circulates the lubricant overall in the direction of the black arrow ε. The arrows γ indicates a state in which there is a force that pushes the lubricant toward the inner periphery overall, and negative pressure is less likely to occur at the inner periphery of the first thrust hydrodynamic portion.

The pattern of the first thrust hydrodynamic groove 3A shown in FIG. 3 generates sufficiently high pressure at the outside diameter part of the groove pattern. Therefore, even if the shaft 2 is tilted or otherwise subjected to rotational moment, a high enough pressure can be generated against this.

In this embodiment, because of the configuration discussed above, any bubbles present in the bearing are smoothly released to the outside, and the angular stiffness (moment stiffness) of the shaft 2 can be increased.

### Embodiment 2

The hydrodynamic bearing device and hydrodynamic bearing-type rotational device of Embodiment 2 of the present invention will be described through reference to FIGS. 5 and 6.

As shown in FIG. 5, the hydrodynamic bearing device of this embodiment comprises a sleeve 21 formed integrally with a second sleeve 21D, the shaft 22, the thrust plate 24, the lubricant 6, the hub 7, the base 8, the rotor magnet 9, and the stator 10.

The shaft 22 is inserted in a state of being capable of rotation in the bearing hole 21A of the sleeve 21. A radial hydrodynamic groove 21B consisting of an asymmetrical herringbone pattern groove is formed in the outer peripheral surface of the shaft 22 and/or the inner peripheral surface of the sleeve 21. A single herringbone groove is shown again in FIG. 5, but there may be two herringbone grooves (upper and lower), with at least one of them having an asymmetrical shape.

The thrust plate 24 has a first thrust hydrodynamic groove (24A) having a spiral groove pattern with a sufficiently large inside diameter (Di) as shown in FIG. 3, and is affixed to either the sleeve 21, the second sleeve 21D, or the base 8.

The bearing gaps near the hydrodynamic grooves 21B and 24A are filled with the lubricant 6.

If needed, the lubricant 6 may fill the pocket-shaped bearing cavity (the entire gap) formed by the sleeve 21, the shaft 22, and the thrust plate 24.

The communicating hole 21G is provided so that the two ends of the radial hydrodynamic groove 21B communicate.

Here, the diagram schematically illustrates how a bubble 15 has become admixed inside the bearing.

In FIG. 5 here, a rotor retainer structure comprising the shaft 22 and the hub 7 is employed, but for the sake of convenience this will not be described. Furthermore, this retainer function may be achieved by a hanging portion 7A of the hub 7 and the sleeve 21 or the second sleeve 21D, or by giving the shaft 22 a stepped structure, and using the shaft 22 and the sleeve 21 or the second sleeve 21D.

The operation of the hydrodynamic bearing device in this embodiment, as shown in FIG. 5, will now be described through reference to FIGS. 5 and 6.

First, when rotation commences, the pressure labeled P in FIG. 3 is generated by the thrust hydrodynamic groove 24A, which lifts the shaft 22. Pressure is also generated by the radial hydrodynamic groove 21B, so the shaft 22 rotates in a non-contact state.

The radial hydrodynamic groove 21B has substantially herringbone pattern. This groove pattern is designed so that its pumping force will transport the lubricant 6 in the direction of the black arrow in the drawing. As a result, the lubricant 6 goes through the bearing hole 21A and then flows into the communicating hole 21G, and repeats this circulation over and over.

The first thrust hydrodynamic groove 24A is provided so as to be in contact with or adjacent to this circulation path, and is a spiral groove with a pump-in pattern formed in a ring-shaped region having in its center a groove-free region (having no hydrodynamic groove). Thus, bubbles tend not to accumulate in the first thrust hydrodynamic groove 24A.

The thrust hydrodynamic groove 24A in FIG. 5 here is the same as the spiral pattern groove with a sufficiently large inside diameter (Di) shown in FIG. 3. That is, since the inside diameter (Di) is large, the pressure distribution is as shown in FIG. 3. Thus, since no low pressure zone is produced in the thrust bearing, there is no danger that oil film separation at the bearing surface will be caused by expanded air if there should be a change in the bearing pressure.

Also, since air is less likely to accumulate inside the first thrust hydrodynamic groove 24A, the pumping force produced in the radial hydrodynamic groove 21B smoothly discharges to the outside any air inside the bearing from the circulation path provided in contact with or adjacent to the first thrust hydrodynamic groove 24A.

Furthermore, the pressure generated at the thrust bearing surface during bearing rotation is sufficiently high at the outer peripheral portion of the groove pattern, and the pressure distribution is such that there is no narrowing of the range L2 of high pressure in the center. Accordingly, the moment stiffness generated at the flange portion 3 can be increased.

FIG. 6 is a diagram of the pressure generated in the hydrodynamic groove of the hydrodynamic bearing device in FIG. 5, and the direction of flow of the lubricant 6 that is circulated by this pressure. FIG. 6 shows the shaft 22 and the thrust plate 24. The white part on the left side of FIG. 6 is a schematic illustration of the circulation path, comprising a radial hydrodynamic portion (bearing hole 21A), the communicating hole 21G, and the lubricant reservoir 21S. Pr and the longer white arrow α (on the shaft drawing) in the drawing represent the pumping pressure of the radial hydrodynamic portion and the direction of this pressure. The arrows γ represent the pumping pressure generated by the spiral hydrodynamic groove of the first thrust hydrodynamic portion and the directions of this pressure. The pumping pressure indicated by the arrow α circulates the lubricant overall in the direction of the black arrow ε. The arrows γ indicates a state in which there is a force that pushes the lubricant toward the inner periphery overall, and negative pressure is less likely to occur at the inner periphery of the first thrust hydrodynamic portion.

As a result, the lubricant 6 is stably supplied to the bearing gap, and the shaft 22 can be rotated in a state of non-contact with respect to the sleeve 21 and the thrust plate 24. Thus, data can be recorded to or reproduced from the rotating recording disk 11 (see FIG. 1) by using a magnetic or optical head (not shown).

In FIG. 5, a second thrust hydrodynamic groove 21H is formed on one of the opposing surfaces between the hub 7 and the sleeve 21. In this case, the circulation path of the lubricant 6 is configured so as to include the second thrust hydrodynamic groove 21H.

Next, FIGS. 7 to 10 show the changes in performance when the pattern shape of the first thrust hydrodynamic groove is changed in the hydrodynamic bearing device (FIG. 1) of this embodiment. In FIGS. 7 to 10, the conventional spiral groove shown in FIG. 14 is labeled “spiral,” while the spiral groove of this embodiment as shown in FIG. 3 is labeled “modified spiral.” Comparative results are given here for the performance of the two different patterns of the thrust hydrodynamic groove.

More specifically, the first groove pattern is the conventional spiral groove shown in FIG. 14, in which case the inside diameter Di is approximately 0.3 mm (at least 0.5 mm or less). The size of this inside diameter Di is set on the basis of the minimum dimension at which a narrow hydrodynamic groove can be worked industrially with a coining press equipped with a metal mold, by electrolytic etching using electrodes, or another such working method. The outside diameter Do is separately and suitably designed according to the weight of the hydrodynamic bearing device, the viscosity of the lubricant 6, and so forth.

The second groove pattern is the spiral groove pattern pertaining to the present invention, in which the inside diameter (Di) is sufficiently large. Since the inside diameter (Di) is large here, the pressure distribution is as shown in FIG. 3, the surface area of the high pressure zone (or the span between high pressure zones) is wider in the thrust bearing portion (3B), and no low pressure zone is produced in the center.

First, FIG. 7 is a comparison of the effective surface area of each bearing groove pattern in the two types of thrust hydrodynamic groove (FIGS. 3 and 14). The “effective surface area of the bearing pattern” here specifies the surface area of the groove pattern formed in a ring-shaped region having a thrust hydrodynamic groove. As shown in FIG. 7, at a given outside diameter, it can be seen that the effective surface area is greater with the first groove pattern (the spiral of FIG. 14) than with the second groove pattern (the modified spiral of FIG. 3).

FIG. 8 is a comparison of the amount of lift in the thrust direction with the groove patterns of the two types of thrust hydrodynamic groove (FIGS. 3 and 14). As shown in FIG. 8, it can be seen that the amount of lift is slightly greater with the first groove pattern (the spiral of FIG. 14) than with the second groove pattern (the modified spiral of FIG. 3).

FIG. 9 is a comparison of the torque loss during steady-state rotation of the two types of thrust hydrodynamic groove (FIGS. 3 and 14). With the first groove pattern (the spiral of FIG. 14), there is considerable torque loss, and this is because the rotational resistance is greater due to the larger bearing surface area. The amount of thrust list is greater with the first groove pattern (FIG. 14), so the torque loss ratio is not as high as the pattern effective surface area ratio.

FIG. 10 is a comparison of the angular stiffness during steady-state rotation of the two types of thrust hydrodynamic groove (FIGS. 3 and 14). As shown in FIG. 10, it can be seen that the angular stiffness ratio is increased much more with the second groove pattern (the modified spiral of FIG. 3) than with the first groove pattern (the spiral of FIG. 14).

Table 1 is a comparison of the performance of the three bearings shown in FIGS. 8 to 10 in the above-mentioned two types of thrust hydrodynamic groove.

Here, the good pattern that has no defects and satisfies performance requirements for the three categories of thrust lift amount, torque loss ratio, and angular stiffness ratio is the “modified spiral” pattern (the “modified spiral” in FIGS. 7 to 10), that is, a spiral groove pattern with a sufficiently large inside diameter (Di).

Also, for the sake of reference, although not depicted in the drawings, experiments with bearings produced from transparent materials have revealed that when the first thrust hydrodynamic grooves 3A and 24A have a herringbone pattern, many bubbles remain in the bearing.

However, with the “spiral” pattern in Table 1, as discussed above, although there is a problem with angular stiffness, bubbles do not remain on the bearing sliding surfaces, and while a very few bubbles are seen around the outside diameter (Do) of the groove pattern, these bubbles were observed to escape through the circulation path provided adjacent to the groove pattern. Also, with the “modified spiral” pattern shown in Table 1, angular stiffness is good, but depending on the design of the pattern dimensions, a small amount of bubbles may remain in the center of the groove pattern. Therefore, it was found that the dimensions need to be optimized during the design phase.

In view of this, the inventors examined design conditions for a good pattern with which no bubbles would remain in the interior of a “modified spiral” pattern, which is good in terms of angular stiffness and torque loss ratio.

TABLE 1

| Groove pattern | Spiral | Modified spiral |
|---|---|---|
| Pattern drawing | 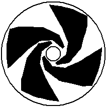 | 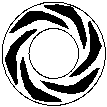 |
| Amount of thrust lift | good | good |
| Torque loss ratio | fair | good |
| Angular stiffness ratio | poor | good |
| Low pressure generation | good | good |
| Remaining bubbles | good | fair to good |

FIG. 15 shows the results of using a transparent bearing that allowed the interior to be observed, and examining whether or not bubbles remained near the thrust hydrodynamic grooves 3A, 3B, 24A, and 21H and near the radial hydrodynamic grooves 1B and 21B while the bearing was rotating when the first thrust hydrodynamic grooves 3A and 24A had the “modified spiral” pattern in Table 1 (a spiral groove pattern with a sufficiently large inside diameter (Di)). In this experiment, when Ri is the radius of the innermost periphery and Ro is the radius of the outermost periphery, and varied the numerical value of the coefficient Ks (Ks=Ri/Ro) from 0% to 100%.

When the modified spiral pattern groove (the first thrust hydrodynamic groove 3A or 24A) was adjacent to the circulation path of the lubricant 6 including the radial hydrodynamic groove 1B or 21B and the communicating hole 1G or 21G, the bubbles were discharged smoothly. In particular, when the value of Ks was 80% or less, the amount of bubbles remaining (the visible surface area (%)) was nearly zero.

However, when the circulation path was provided adjacent to the modified spiral pattern groove (the first thrust hydrodynamic groove 3A or 24A), when it was provided at a location 1 mm away, for example, as shown in FIG. 15, it was observed how bubbles with a surface area ratio of close to 30% (when the bubbles were present in the formation range of the hydrodynamic groove) remained near the outer periphery of the first thrust hydrodynamic groove 3A or 24A, and it was found that the bubbles were not being discharged to the outside.

In FIG. 15, in the range where the value of Ks is very small (the region at the left end of the graph), this means that the pattern is “spiral” rather than “modified spiral.”

Here, the bubbles that are usually observed have a width or diameter of at least 0.5 mm, so as long as the distance between the groove pattern and the circulation path is between 0 and 0.5 mm, we can consider them to be adjacent.

FIG. 16 is a graph of the proportional surface area of bubbles remaining in the bearing, and the distance S1 between the circulation path and the modified spiral pattern groove (the first thrust hydrodynamic groove 3A) in FIG. 2, or the distance S2 between the circulation path and the modified spiral pattern groove (the first thrust hydrodynamic groove 24A) in FIG. 5. If the distance of S1 and S2 is 0.5 mm or less, bubbles will be smoothly discharged to the outside and not remain in the bearing, so good hydrodynamic bearing device performance can be attained. On the other hand, if S1 and S2 are over 0.5 mm, any bubbles present in the bearing will be less apt to be discharged to the outside, and the effect of these remaining bubbles may diminish performance of the bearing.

As shown in FIGS. 17A to 17C and FIG. 18, the distances S1 and S2 refer to the distance from the outermost periphery of the first thrust hydrodynamic grooves 3A and 24A to the circulation path of the lubricant 6.

FIG. 11 shows the change in the friction torque (torque loss; g/cm) and the angular stiffness ratio (%) when the numerical value of the coefficient Ks (Ks=Ri/Ro) was varied from 0% to 100% and when the first thrust hydrodynamic grooves 3A and 24A were the “modified spiral” pattern in Table 1 (a spiral pattern groove with a sufficiently large inside diameter (Di)). Here, Ri is the radius of the innermost periphery and Ro is the radius of the outermost periphery.

When the coefficient Ks is between 0% and 50%, the friction torque ratio (torque loss ratio; %) decreases as the coefficient Ks increases. This is because when the value of Ks is within this range, the thrust lift amount is sufficiently large, but as Ks increases, the bearing surface area decreases, and the rotational friction resistance drops.

However, if Ks is over 80%, the lift amount declines, so the friction torque ratio (torque loss ratio) increases. As a result, it was found that the optimal numerical value of the coefficient Ks is between 50% and 80%.

As to the value of the angular stiffness ratio, satisfactory performance was not obtained when Ks was under 50%, and it was clear that 50% or higher was preferable.

The result of the above investigation was that the groove pattern is ideally designed so that the value of Ks (Ri/Ro) falls between 0.5 and 0.8.
Ri: radius of the innermost periphery of the groove pattern
Ro: radius of the outermost periphery of the groove pattern

Also, as shown in FIGS. 4 and 6, the hydrodynamic bearing device of the present invention has a circulation path formed so as to include the radial hydrodynamic groove 1B and the communicating hole 1G. A first thrust bearing is disposed so as to be in contact with this circulation path.

With this configuration, it was found that if the groove pattern of the first thrust bearing was that of a spiral groove with a pump-in pattern formed in a ring-shaped region having a groove-free region in the center, as shown in FIG. 3, then the combined effect of these is tremendous.

Specifically, with a hydrodynamic bearing device having no circulation path (not shown), the effect of employing the thrust groove pattern pertaining to the present invention is that bubbles do not accumulate in the interior. However, since the bubbles 15 have merely been shunted to another location in the bearing, there is the risk that they will work their way back to the bearing surface.

In view of this, as discussed above, a first thrust hydrodynamic groove is disposed in contact with or adjacent to the circulation path, and this first thrust hydrodynamic groove is a spiral groove with a pump-in pattern formed in a ring-shaped region, and the effect of employing this combined structure is that bubbles inside the bearing can be completely discharged to outside the bearing.

Furthermore, this invention is not something whereby a designer merely optimizes the design parameters by ordinary efforts, but is instead a completely novel invention that clarifies the accumulation and flow of bubbles.

When the hydrodynamic bearing device of this embodiment is incorporated into the recording and reproducing apparatus shown in FIG. 12 and used as a compact notebook computer or a mobile device, there is no decrease in performance when it is used in a low-pressure environment such as high up in the mountains or flying, and the high performance of the product can be obtained over a wide range of environments.

As discussed above, a low pressure zone can be prevented from being produced in a thrust bearing by designing the groove pattern of the thrust bearing so that no air remains inside the bearing. Thus, even if the usage environment of the product should change and a pressure change should occur inside the bearing, there is no risk that the air will expand and cause oil film separation on the bearing surface. Also, the pressure generated at the thrust bearing surface during rotation of the bearing has a distribution such that the pressure is sufficiently high at the outer peripheral portion of the groove pattern. Therefore, the angular stiffness of the thrust bearing generated with the thrust plate can be increased. Thus, a hydrodynamic bearing device and a recording and reproducing apparatus with higher performance and a longer service life can be obtained.

Also, as shown in FIG. 12, a recording and reproducing apparatus with higher reliability can be provided by mounting the above-mentioned hydrodynamic bearing device in a recording and reproducing apparatus that includes a lid 16 and a head actuator unit 17.

In the above embodiment, the sleeve 1 is made of pure iron, stainless steel, a copper alloy, an iron-based sintered metal, or the like. The shaft 2 is made of stainless steel, high-manganese chromium steel, or the like, and its diameter is from 2 to 5 mm. The lubricant 6 is a low viscosity ester-based oil.

In FIGS. 1, 2, and 5, the communicating hole 1G is provided at just one place, but the same effect can be obtained when communicating holes are provided at a plurality of places, rather than just one.

The present invention relates to a hydrodynamic bearing device in which a communicating hole and a radial hydrodynamic groove constitute the circulation path of a lubricant, and the lubricant is circulated by pumping force (circulation force or transport force) of the hydrodynamic groove, wherein bubbles are less apt to accumulate in the first thrust hydrodynamic groove, and bubbles can be smoothly discharged through the communicating hole, so it is less likely that there will be insufficient lubricant at the thrust bearing surface. The pressure generated at the thrust bearing surface during rotation of the bearing has a distribution such that the pressure is sufficiently high at the outer peripheral portion of the groove pattern, and the moment stiffness generated between the thrust plate and the shaft (or flange) is high. Thus, a hydrodynamic bearing device can be obtained that maintains its good performance and reliability even when subjected to external force.

### INDUSTRIAL APPLICABILITY

The hydrodynamic bearing device pertaining to the present invention has the effect of greatly enhancing the reliability of a bearing, and can therefore be widely applied to recording and reproducing apparatuses and other such apparatuses in which hydrodynamic bearing devices are installed.

### BRIEF DESCRIPTION OF THE DRAWINGS

FIG. 1 is a cross section of the hydrodynamic bearing device pertaining to a first embodiment of the present invention;

FIG. 2 is a detail cross section of the hydrodynamic bearing device in FIG. 1;

FIG. 3 is a diagram of a thrust hydrodynamic groove included in the hydrodynamic bearing device in FIG. 1;

FIG. 4 is a diagram of the circulation path of the lubricant in the hydrodynamic bearing device in FIG. 1;

FIG. 5 is a detail cross section of the hydrodynamic bearing device pertaining to a second embodiment of the present invention;

FIG. 6 is a diagram of the circulation path of the lubricant in the hydrodynamic bearing device in FIG. 2;

FIG. 7 is a graph of the effect surface area of the thrust bearing pattern in a working example of the present invention;

FIG. 8 is a graph of the amount of lift of the thrust bearing in a working example of the present invention;

FIG. 9 is a graph of the torque loss of the thrust bearing in a working example of the present invention;

FIG. 10 is a graph of the angular stiffness (moment stiffness) of the thrust bearing in a working example of the present invention;

FIG. 11 is a graph of the characteristics of the spiral pattern groove in a working example of the present invention;

FIG. 12 is a cross section of a recording and reproducing apparatus equipped with the hydrodynamic bearing-type rotational device of the present invention;

FIG. 13 is a cross section of a conventional hydrodynamic bearing device;

FIG. 14 is diagram of the thrust hydrodynamic groove included in a conventional hydrodynamic bearing device;

FIG. 15 is a graph of the characteristics of the spiral pattern groove in a working example of the present invention;

FIG. 16 is a graph of the relationship between the distance between the circulation path and the first thrust hydrodynamic groove and the surface area ratio of bubbles remaining inside the bearing;

FIGS. 17A to 17C are detail views of the distance between the lubricant circulation path and the first thrust hydrodynamic groove in the hydrodynamic bearing device of FIG. 2; and

FIG. 18 is a detail view of the distance between the lubricant circulation path and the first thrust hydrodynamic groove in the hydrodynamic bearing device of FIG. 5.

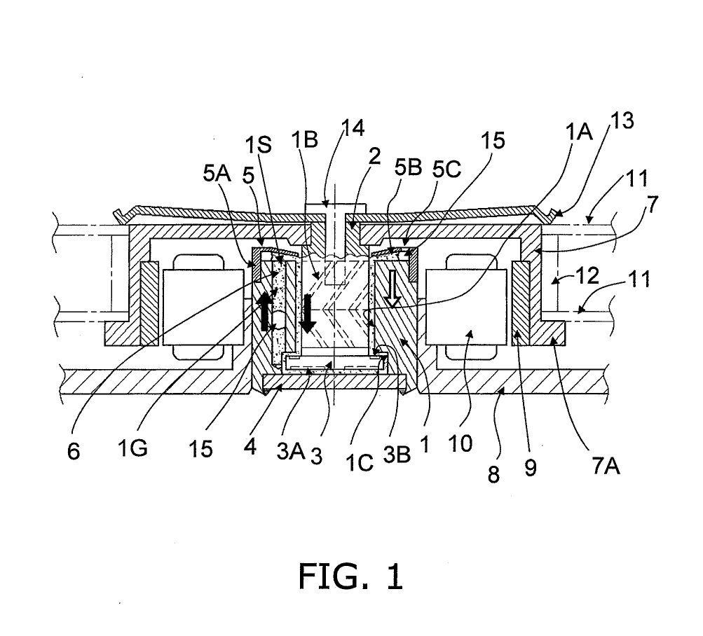

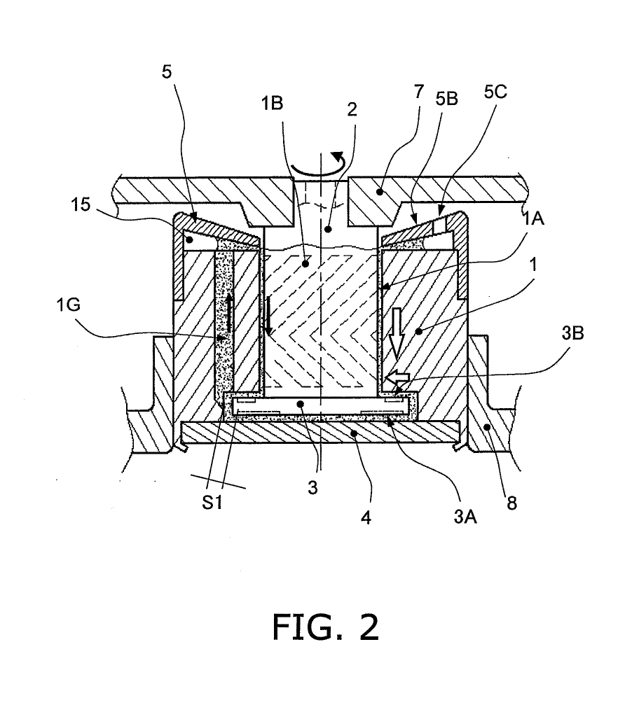

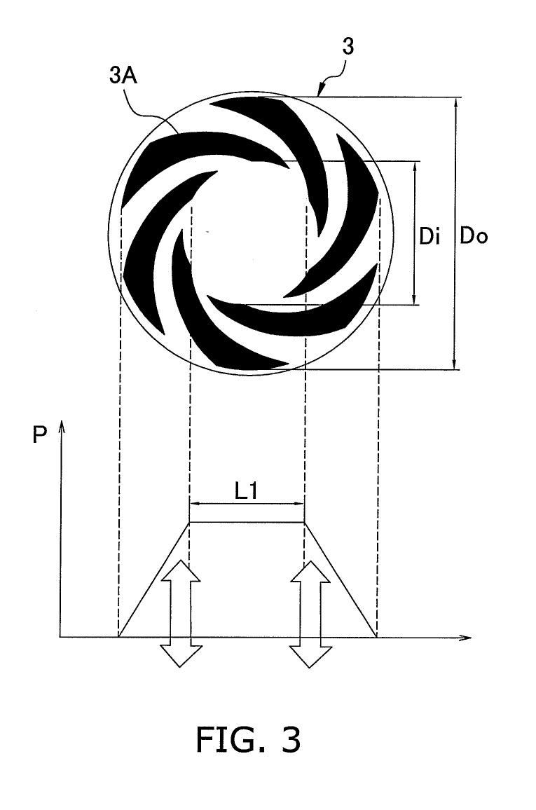

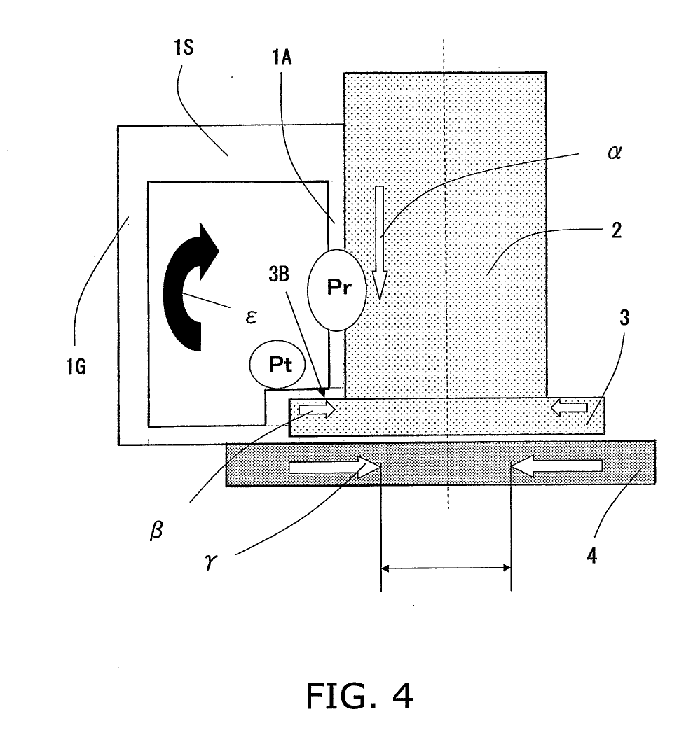

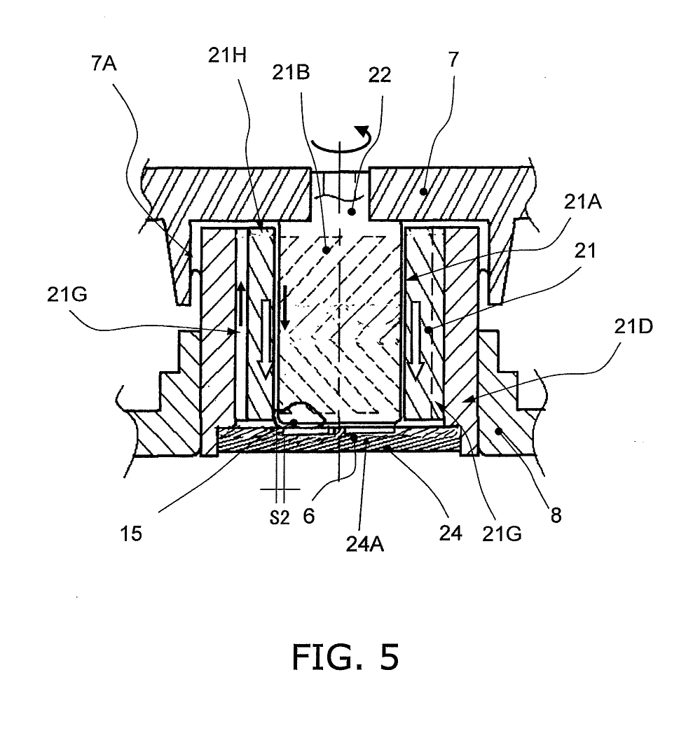

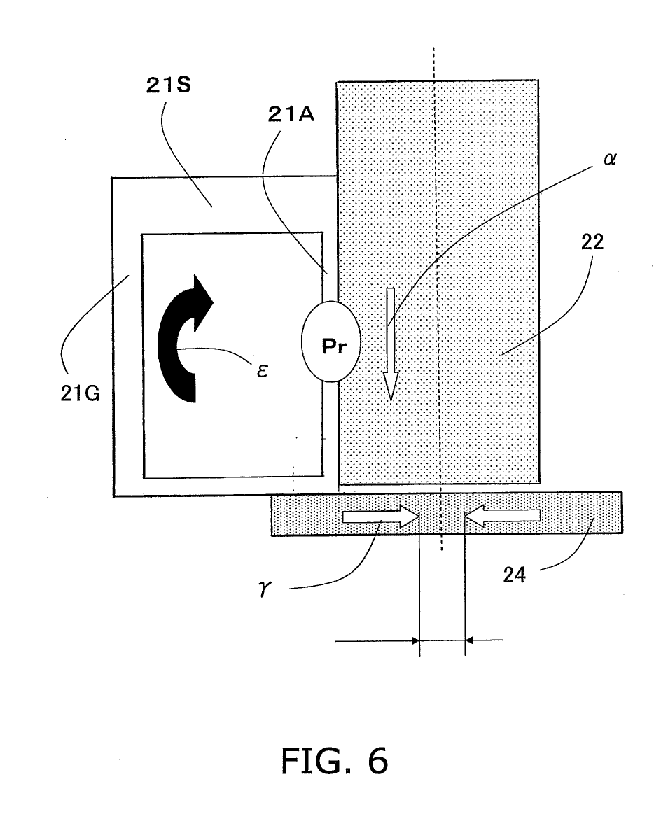

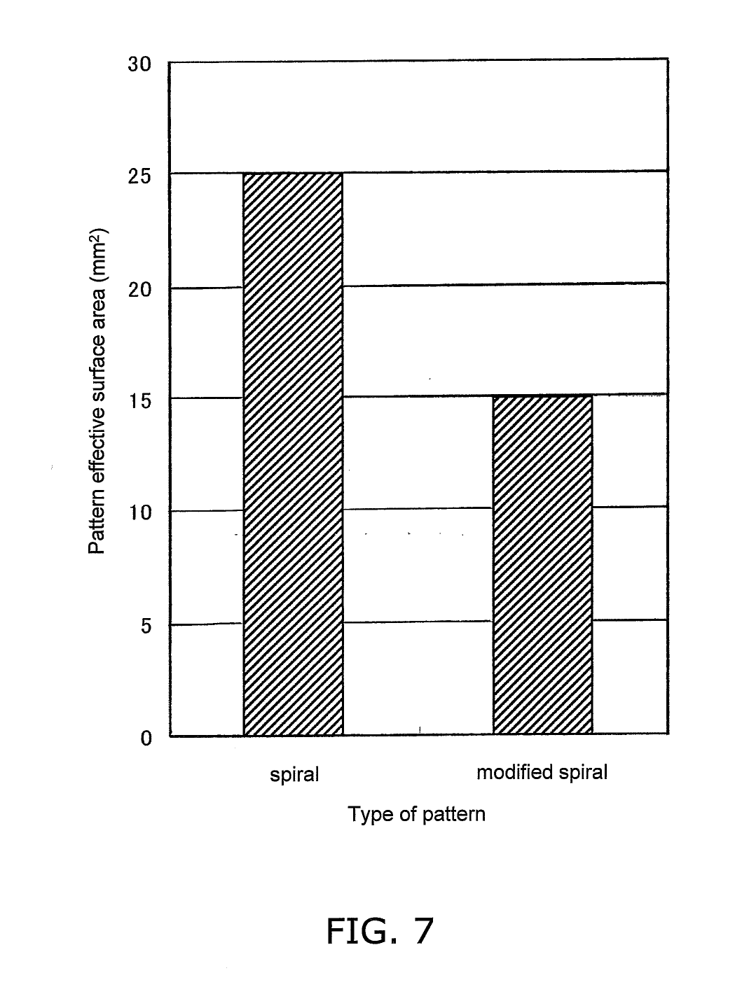

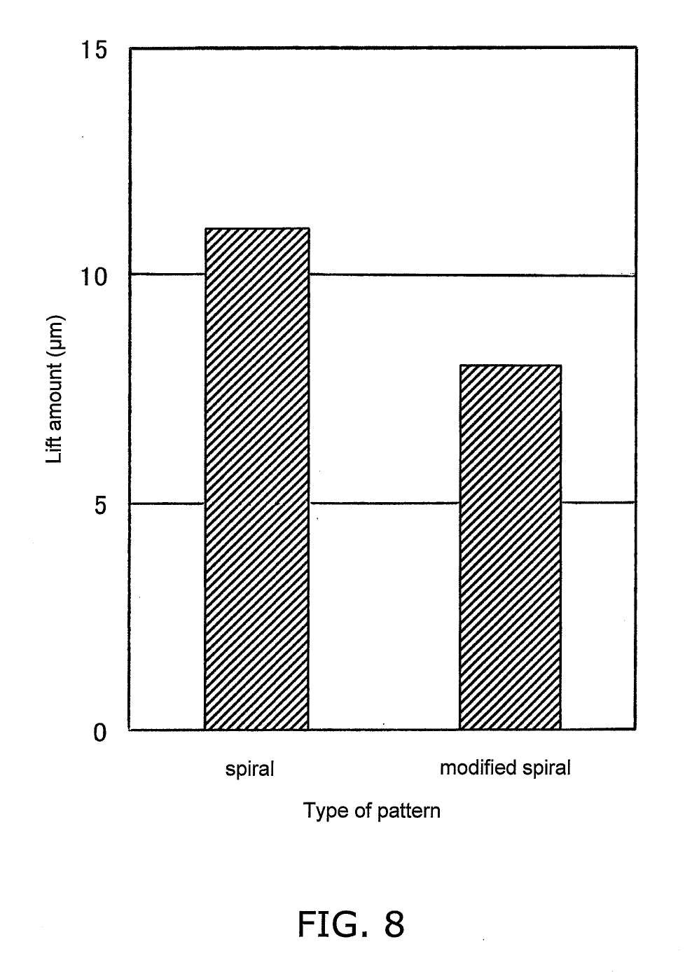

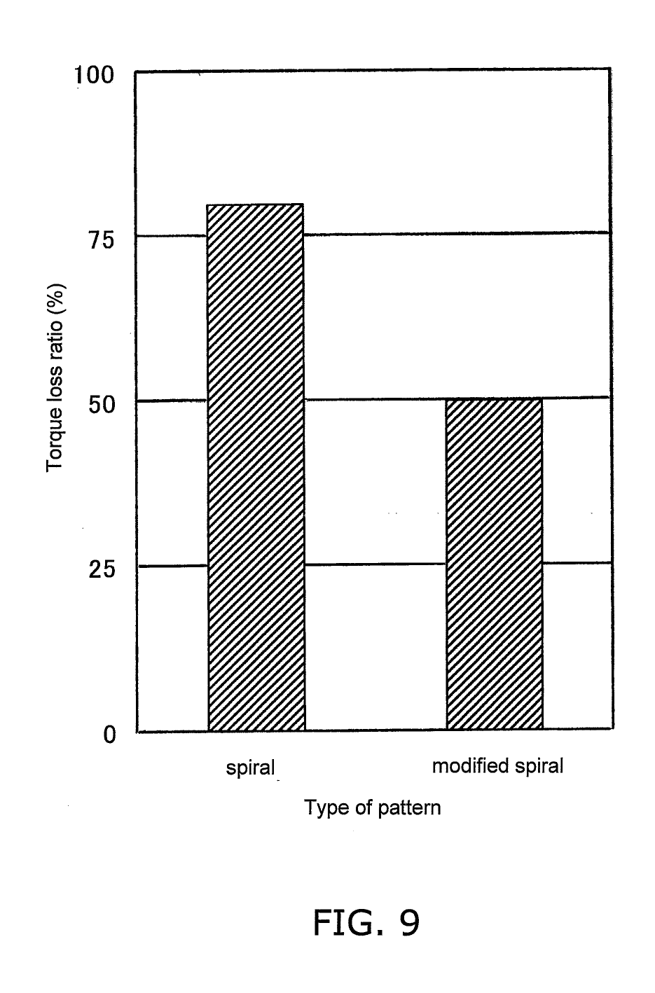

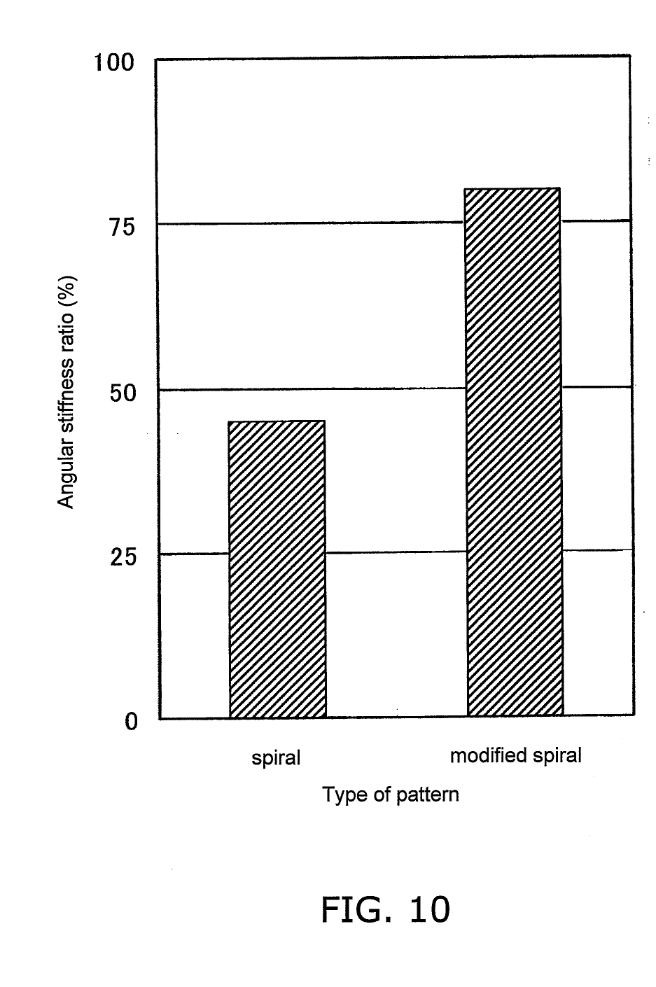

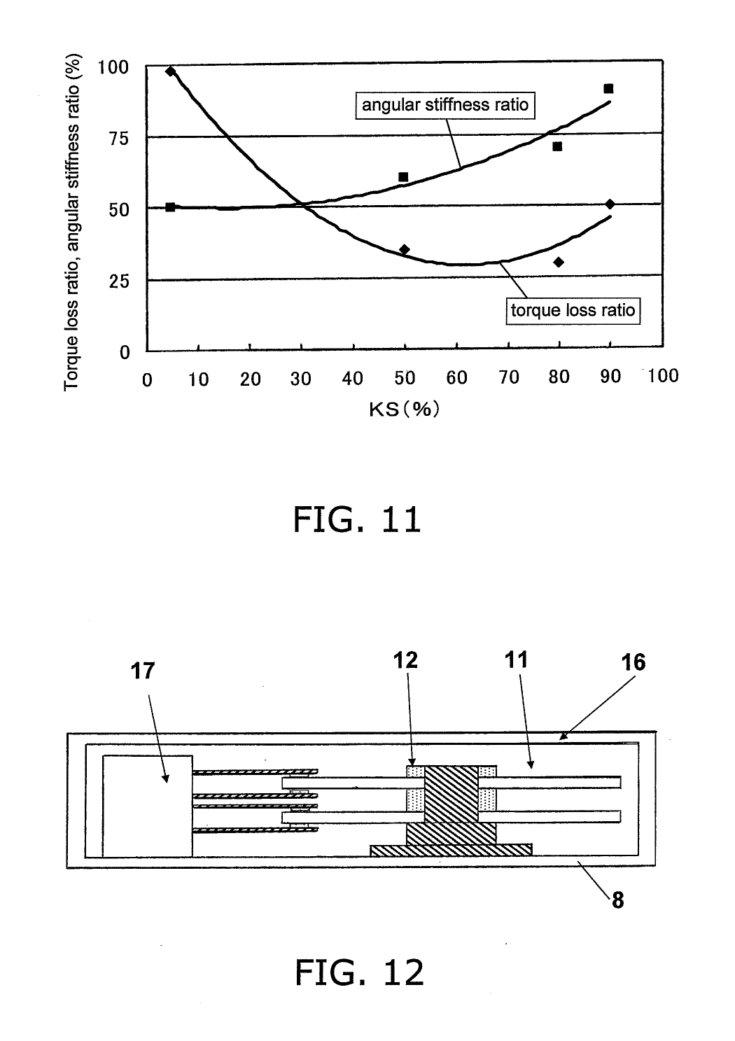

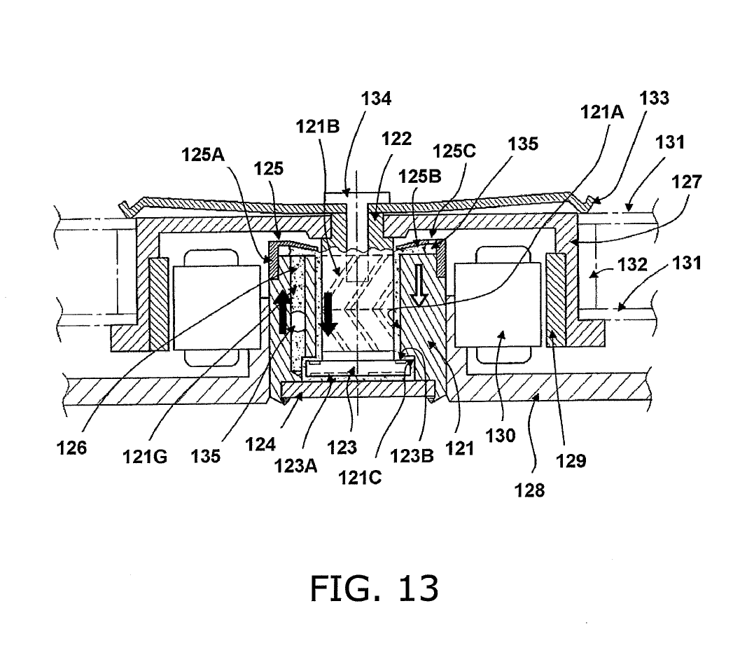

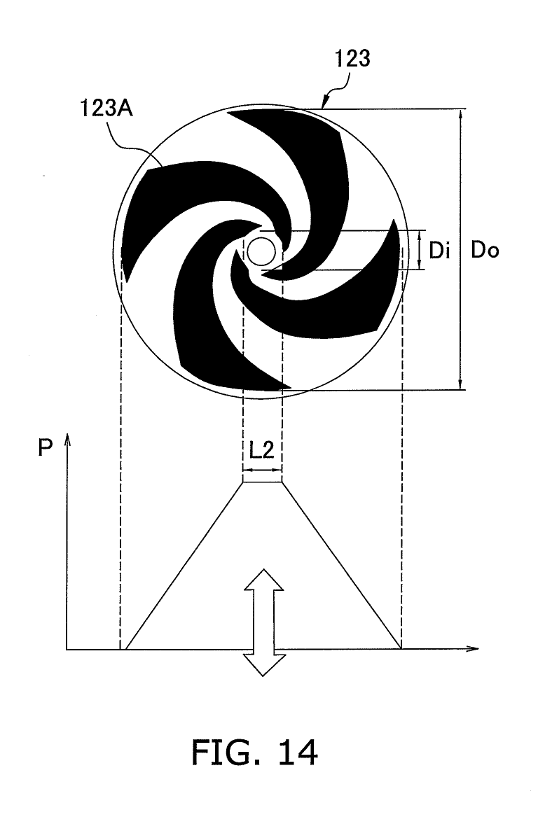

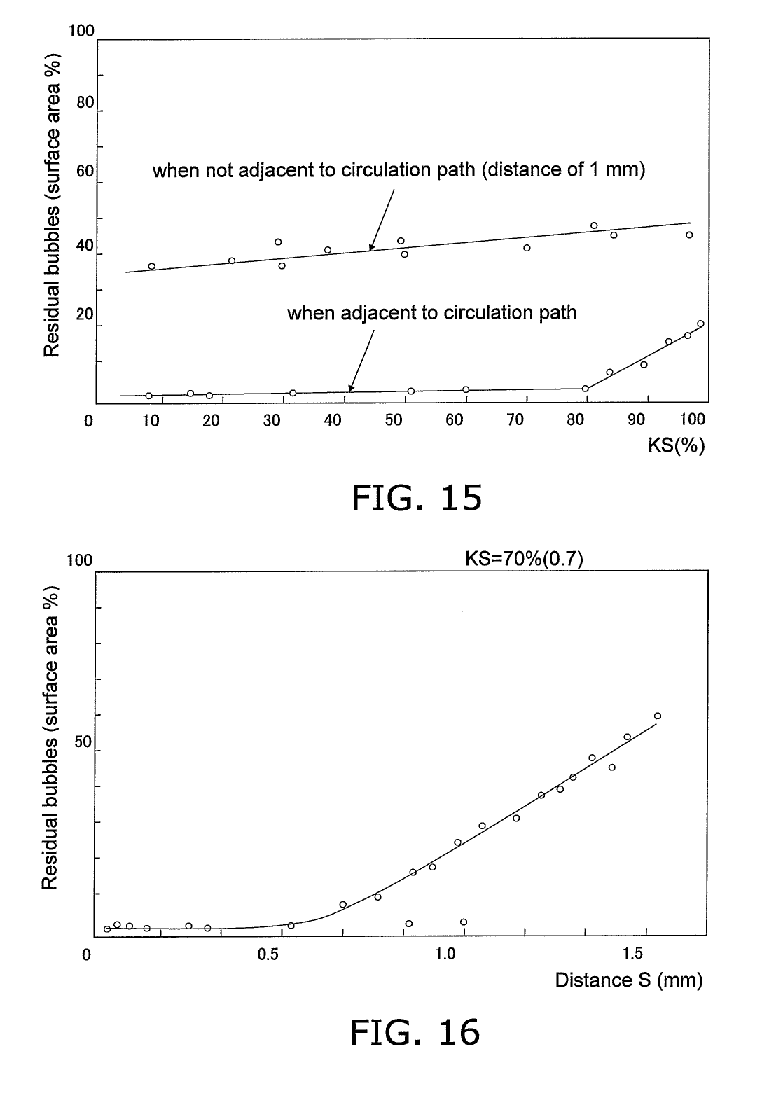

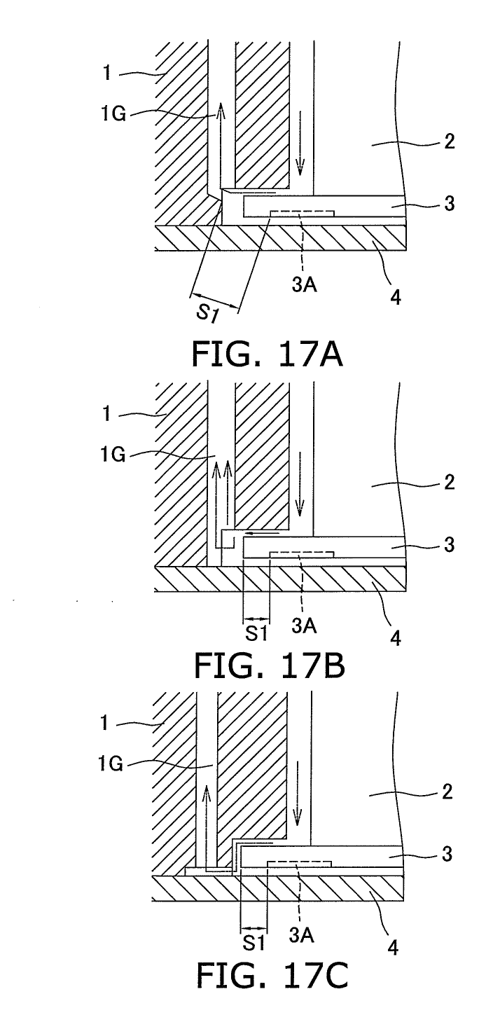

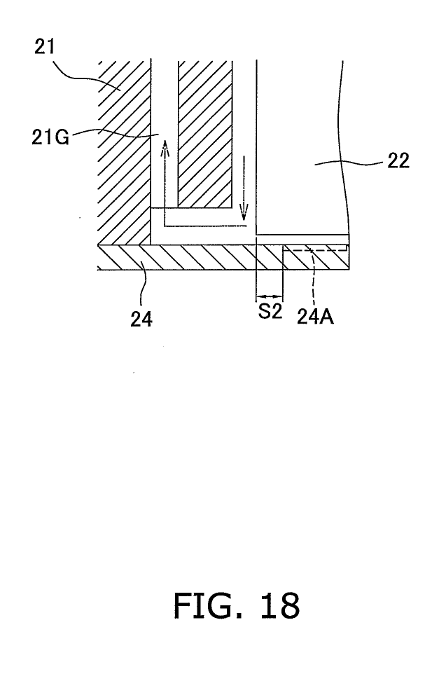

1. A hydrodynamic bearing device, comprising:
a shaft;
a sleeve which has a bearing hole with an open end that opens and a closed end that is blocked off by a blocking member in the axial direction, into which the shaft is inserted in so as to be capable of relative rotation;
a lubricant that fills a microscopic gap between the shaft and the sleeve;
a communicating hole that constitutes the circulation path of the lubricant along with the microscopic gap; and
a first thrust bearing surface of the blocking member and/or the shaft, in which a first thrust hydrodynamic groove is formed as a pump-in pattern spiral groove in a ring-shaped region having a groove-free region in the center and is disposed near the circulation path.

2. The hydrodynamic bearing device according to claim 1,
wherein the ratio Ks of these (Ri/Ro) satisfies the following relation when Ri is the radius of the innermost periphery of the spiral groove, and Ro is the radius of the outermost periphery.
0.5<Ks<0.8

3. The hydrodynamic bearing device according to claim 1,
wherein the first thrust hydrodynamic groove is disposed near the circulation path, within a range of 0 to 0.5 mm.

4. The hydrodynamic bearing device according to claim 1,
further comprising a radial bearing surface on the outer peripheral surface of the shaft and/or the inner peripheral surface of the sleeve, in which is formed a radial hydrodynamic groove having an asymmetrical groove pattern that generates a flow that conveys lubricant from a side of the open end toward a side of the closed end.

5. The hydrodynamic bearing device according to claim 1, further comprising:
a ring-shaped flange portion provided integrally to the shaft on the surface opposite the blocking member; and
a second thrust hydrodynamic groove that is provided to a surface of the flange portion and/or a surface of the sleeve opposite to each other, and that generates pressure in the opposite direction from that of the axial direction pressure imparted from the first thrust hydrodynamic groove to the shaft,
wherein the circulation path is formed so as to include the radial hydrodynamic groove, the communicating hole, and the second thrust hydrodynamic groove.

6. The hydrodynamic bearing device according to claim 1, further comprising:
a hub provided on the open end side of the shaft; and
a second thrust hydrodynamic groove that is provided to a surface of the sleeve and/or a surface of the hub opposite to each other, and that generates pressure in the opposite direction from that of the axial direction pressure imparted from the first thrust hydrodynamic groove to the shaft,
wherein the circulation path is formed so as to include the radial hydrodynamic groove, the communicating hole, and the second thrust hydrodynamic groove.

7. The hydrodynamic bearing device according to claim 1,
wherein the asymmetrical groove pattern of the radial hydrodynamic groove is a herringbone groove such that the groove on the open end side of the bearing hole is longer than the groove on the closed end side, with the groove apex as the center.

8. A recording and reproducing apparatus equipped with the hydrodynamic bearing device according to claim 7.
